(19) United States
(12) Patent Application Publication
(10) Pub. No.: US 2026/0158837 A1
(43) Pub. Date: Jun. 11, 2026

(54) DEVICE FOR SECURING WITH A SOCKET ASSEMBLY OF A TRAILER

(71) Applicant: SnatchLatch, LLC, Flower Mound, TX (US)

(72) Inventors: Timothy Boykin, Plano, TX (US); Jesus Martinez, Garland, TX (US)

(21) Appl. No.: 19/193,539

(22) Filed: Apr. 29, 2025

Related U.S. Application Data
(60) Provisional application No. 63/729,205, filed on Dec. 6, 2024.

(51) Int. Cl. B60D 1/60; B60D 1/06

(52) U.S. Cl. CPC B60D 1/60; B60D 1/06

(57) ABSTRACT

A device for securing with a socket assembly of a trailer hitch is disclosed. The device comprises a housing having a bottom wall and a top wall portion with a slotted rear portion. The device comprises a locking portion for receiving a lock therewithin. The device comprises a rearwardly sliding plate having a male connector protrusion for coupling to the socket assembly. The sliding plate is movable adjacent the bottom wall between a front position and a rear position. At the rear position, the sliding plate allows detachable attachment of the socket assembly with the sliding plate. At the front position, the sliding plate engages with the lock to restrict the movement of the sliding plate to the rear position. The device comprises a cap removably disposed at a covering position where the cap prevents access to the lock when the lock is received within the locking portion.

### FIELD OF THE DISCLOSURE

The present disclosure generally relates to locking devices, and more particularly to a device for securing socket assembly of a trailer hitch of a trailer to prevent unauthorized access to the socket assembly.

### BACKGROUND

Trailers are widely used in various industries for transporting goods and as recreational vehicles. The secure attachment of a trailer to a towing vehicle is typically achieved through a hitch assembly. This assembly generally includes a hitch ball mounted on the towing vehicle and a coupler with a socket assembly mounted on the trailer. The socket is designed to fit snugly over the hitch ball, and a latching mechanism is used to secure the connection, ensuring that the trailer remains attached during transport.

Various types of coupler locks have been developed to secure the connection, particularly when the trailer is unattended. However, one of the issues with conventional coupler locks is their vulnerability to theft. Unauthorized individuals can easily detach the trailer from the towing vehicle or steal the trailer when it is parked and unhitched. For instance, conventional coupler locks can be tampered and manipulated with common tools, rendering them ineffective. Further, conventional coupler locks are cumbersome to use and insufficiently secure. For instance, conventional coupler locks may be difficult to install or remove, requiring multiple steps or specialized tools. This complexity can discourage users from consistently using the lock, especially during short stops or quick detachments.

### SUMMARY

Disclosed herein is a device for securing with a socket assembly of a trailer hitch.

The device can include a housing having at least a longitudinal axis. The housing can comprise a bottom wall, a top wall portion having a slotted rear portion and a first end portion at the front end thereof. The device can include a locking portion extending from the first end portion of the housing at least partially along the longitudinal axis. The locking portion can be configured to receive a lock therewithin, wherein the locking portion defines an opening at the front end of the locking portion to retain a lock therein and to allow access to the lock through the locking portion. The device can include a rearwardly sliding plate disposed at the slotted rear portion of the housing and having a male connector protrusion configured to be coupled to the socket assembly of the trailer hitch. The sliding plate can be movable adjacent the bottom wall within the slotted rear portion of the housing between a front position where the male connector protrusion is at least mostly enclosed by the housing and a rear position where the male connector protrusion is at least mostly outside the rear of the housing. At the rear position, the sliding plate is configured to allow detachable attachment of the socket assembly of the trailer hitch with the sliding plate. At the front position, the sliding plate is configured to be engaged with the lock and be locked thereby so as to restrict the movement of the sliding plate to the rear position. The device can include a cap configured to be removably disposed in a covering position where the cap covers at least the opening of the locking portion and a majority of the lock when the lock is in place, thereby preventing access to the lock through the opening of the locking portion.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1A illustrates an isometric view of a device engaged with a socket assembly of a trailer according to the disclosure;

FIG. 1B illustrates an exploded view of the device of FIG. 1A;

FIG. 1C depicts a close-up view of a housing of the device according to the disclosure;

FIG. 2A depicts a front isometric view of a lock according to the disclosure;

FIG. 2B depicts a rear isometric view of the lock of FIG. 2A;

FIG. 3A depicts the device with a cap of the device in a covering position according to the disclosure;

FIG. 3B depicts the device with the cap of the device in an uncovering position according to the disclosure;

FIG. 4A depicts the device with a sliding plate in a rear position according to the disclosure;

FIG. 4B depicts the device with a sliding plate in a front position according to the disclosure; and

FIGS. 5A-5F depict sequential stages in shifting the device from the unlocked state to the locked state according to the disclosure.

### DETAILED DESCRIPTION

Generally, trailers which are widely used for transporting various types of cargo are towed by a towing vehicle. The trailer is attached to the towing vehicle via a coupling system in which a towing hitch is coupled to the trailer, in particular, to a trailer hitch comprising a socket assembly. As is generally understood, the towing hitch includes a hitch ball designed to fit into a socket or a recess of the socket assembly for coupling of the trailer with the towing vehicle.

“Trailer hitch” as used herein refers to an arrangement attached to a tongue of the trailer which facilitates coupling of the trailer to the vehicle. The trailer hitch may alternatively be referred to as a trailer coupler, a trailer lock assembly, trailer socket mechanism, and the like.

“Socket assembly” as used herein refers to an arrangement associated with the trailer hitch of the trailer which is configured to engage with the towing hitch of the towing vehicle for establishing connection with the towing vehicle. In an embodiment, the socket assembly may form a part of the trailer hitch which is attached to a tongue of the trailer.

When the trailer is not coupled with the towing vehicle, for instance when the trailer is parked and unhitched, it is desired to secure the trailer and prevent the trailer to be connected to a towing vehicle. Various embodiments of a device for securing a trailer hitch having a socket assembly are disclosed. The device is generally configured to engage with the socket assembly of the trailer and prevent unauthorized access to the socket assembly of the trailer.

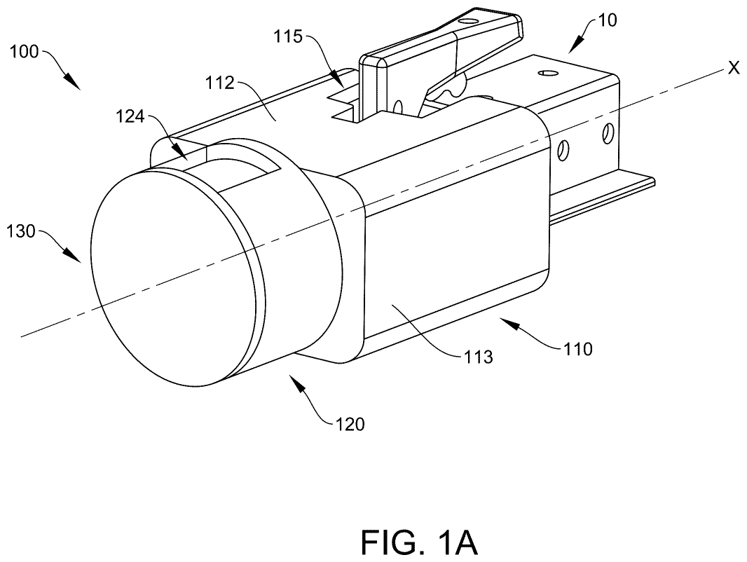

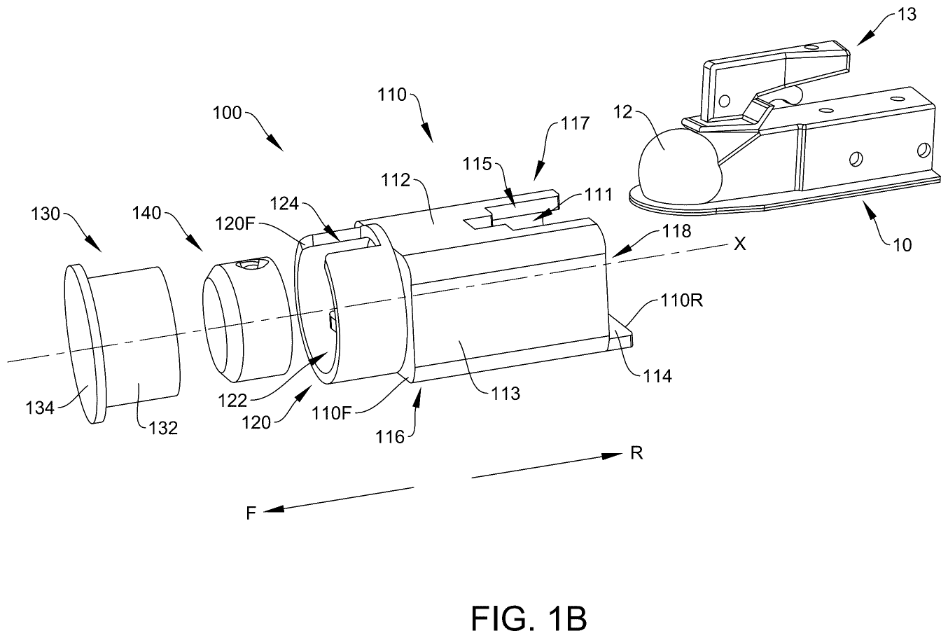

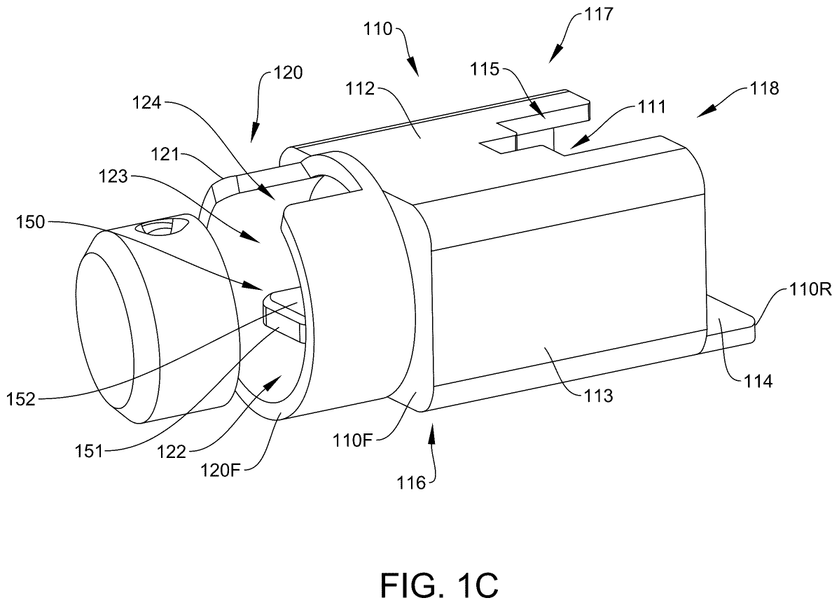

FIGS. 1A-1B depict a device for securing a trailer having a socket assembly is described. FIG. 1A illustrates an isometric view of the device 100 engaged with a socket assembly 10 of a trailer. FIG. 1B illustrates an exploded view of the device 100 of FIG. 1A. FIG. 1C depicts a close-up view of a housing of the device 100. Details of the device 100 will be described by referring collectively to FIGS. 1A-1C.

The device 100 as depicted in FIG. 1A is in a locked state with respect to the socket assembly 10, in that, the device 100 securely engages with the socket assembly 10 and prevents unauthorized access to the socket assembly 10. Unauthorized access as used herein refers to accessing the socket assembly 10 for coupling to a towing vehicle by an unauthorized person, for instance, thieves. The device 100 when in the locked state with respect to the socket assembly 10 prevents the socket assembly 10 to be coupled with a towing vehicle.

The socket assembly 10 may be associated with a trailer hitch (or a trailer coupler) and may be attached to a tongue of a trailer (not shown). The socket assembly 10 may comprise a main body 11 and a socket 12. The socket 12 may be a hollow, semi-spherical recess or cavity that is dimensioned to engage with a towing hitch of a towing vehicle, such as a hitch ball of the towing hitch. The socket assembly 10 may comprise a locking mechanism 13 which is generally engaged after the hitch ball is inserted into the recess of the socket 12 so as to lock the socket onto the hitch ball. The locking mechanism 13 may be a lever or a latch.

It is appreciated that although the socket assembly 10 may be of any other configuration that can be secured with a towing hitch, without departing from the scope of the invention.

The device 100 may comprise a housing 110 extending at least along a longitudinal axis X. In an embodiment, the housing 110 may be a hollow housing having an internal space 111 therewithin. The internal space 111 within the housing 110 may enable movement of one or more components of the device within the housing 110, as will be described further below. The internal space 111 within the housing 110 may further enable the socket assembly 10 to be received therein. In an embodiment, the housing 110 may be formed of a hardened steel or other high-strength materials to resist drilling, cutting, prying, and other forms of tampering.

The housing 110 may extend between a front end 110F and a rear end 110R. For purposes of description herein, the terms “front”, “rear”, “upper”, “lower”, “upright”, “vertical”, “horizontal”, and derivatives thereof shall relate to the housing 110, and the device 100, as oriented in FIGS. 1A and 1B. For reference, a direction lines are depicted in FIG. 1B to specify the front direction F and the rear direction R. In particular, the rear side of the device 100 is a side facing the socket assembly 10.

The housing 110 may comprise a top wall portion 112, side walls 113, and a bottom wall 114. The bottom wall 114 and the side walls 113, along with the top wall portion 112, define the internal space 111 of the housing 110. The internal space 111 may be configured to at least partially accommodate a sliding plate (such as a sliding plate 150) therewithin, as will be described further below.

The housing 110 may comprise a slotted rear portion 115. In an embodiment, the slotted rear portion 115 may be formed as a slot in the top wall portion 112. The slotted rear portion 115 may be proximal to the rear end 110R of the housing 110. The slotted rear portion 115 may be configured to allow the socket assembly 10 to be at least partially received within the housing 110.

The housing 110 may comprise a first end portion 116 proximate the front end 110F of the housing 110 and a second end portion 117 proximate the rear end 110R of the housing 110. The second end portion 117 may define a socket receiving opening 118 configured to allow the socket assembly 10 to be received at least partially within the housing 110. The socket receiving opening 118, along with the slotted rear portion 115, may together allow the socket assembly 10 to be received at least partially within the housing 110. In an embodiment, the socket receiving opening 118 may be considered as a part or extension of the slotted rear portion 115, or the slotted rear portion 115 may be considered as a part or extension of the socket receiving opening 118. In an embodiment, both the slotted rear portion 115 and the socket receiving opening 118 together may be referred to as the slotted rear portion 115. In an embodiment, both the slotted rear portion 115 and the socket receiving opening 118 together may be referred to as the socket receiving opening 118 such that the socket receiving opening 118 can be considered as partially formed in the top wall portion 112 of the housing 110.

The device 100 may comprise a locking portion 120 and a cap 130. The device 100 may comprise a cap 130 configured to engage with the locking portion 120. The cap 130 acts as a cover to prevent access to one or more portions of the locking portion 120, to components of the device 100 through the locking portion 120, and to one or more external elements disposed within the locking portion 120.

The locking portion 120 may extend from the housing 110. The locking portion 120 may extend from the first end portion 116 of the housing 110 at least partially along the longitudinal axis X. In an embodiment, the locking portion 120 may be fixedly attached with the housing 110 at the first end portion 116 at the front end 110F. The locking portion 120 may facilitate fixing of the device 100 with respect to a lock 140, and further, facilitate the device 100 to be in a locked state with respect to the socket assembly 10. In an embodiment, the locking portion 120 may be formed of a similar material as the housing 110.

In an embodiment, the locking portion 120 may be integrally formed with the first end portion 116 of the housing 110. In an embodiment, the locking portion 120 may be separately formed from the housing 110 and fixedly coupled to the first end portion 116 during manufacturing of the device 100. In an embodiment, the locking portion 120 may be formed together with the housing 110 such that the locking portion 120 forms a part of the housing 110. In an embodiment, the locking portion 120 may be formed of hardened steel or other high-strength materials to resist drilling, cutting, and other forms of tampering.

In an embodiment, the locking portion 120 may comprise a wall 121 defining the locking portion 120. In an embodiment, the locking portion 120 may be a tubular member and the wall 121 may be a tubular wall. It is appreciated that the locking portion 120 may be of any other configuration instead a tubular member, without departing from the scope of the invention. For instance, as a non-limiting example, the locking portion 120 may be a cubical member having a cubical wall. The locking portion 120 may be configured to receive a lock 140 therewithin. The locking portion 120 may enable access to a sliding plate (such as a sliding plate 150) to facilitate locking of the device 100 with respect to socket assembly 10, as will be described in detail further below.

The locking portion 120 may comprise a lock receiving opening 122, referred to as the opening 122 hereinafter, for receiving the lock 140 within the locking portion 120. The wall 121 of the locking portion 120 may extend from the front end 110F of the housing 110 till a front end 120F of the locking portion 120. The opening 122 may be defined at the front end 120F of the locking portion 120. The wall 121 may define a lock space 123 within the locking portion 120. The lock 140 may be received within the lock space 123 via the opening 122 at the front end 120F of the locking portion 120. The lock space 123 may be configured to retain the lock 140 therein and allow access t0 the lock 140. The lock space 123 may further be configured to accommodate at least some portions of a sliding plate, such as the sliding plate 150.

The locking portion 120 may comprise a gap 124 configured to allow access to the lock space 123, and to the lock 140 when the lock 140 is received within the locking portion 120. The gap 124 may be formed so as to allow access through the locking portion 120 in a direction transverse to the longitudinal axis X. In an embodiment, the gap 124 may be formed in the wall 121 of the locking portion 120. The gap may define an access passage in a direction transverse to the longitudinal axis X through the wall 121, the access passage enabling access to the lock 140 when the lock 140 is received within the locking portion 120. For instance, the access passage may enable access to the lock 140 for locking or unlocking the lock 140, and consequently, locking and unlocking of the device 100 with the lock 140. In an embodiment, the gap 124 may be formed as a cut-out in the wall 121 of the locking portion 120. In an embodiment where the locking portion is a tubular member, the gap 124 may be formed in the tubular wall of the locking portion 120.

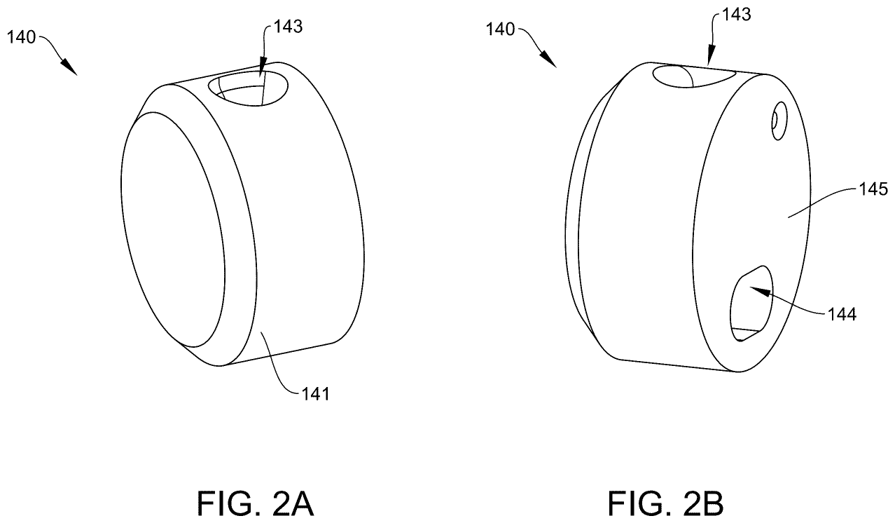

Referring additionally to FIGS. 2A-2B, the lock 140 is described. FIG. 2A depicts a front isometric view of the lock 140. FIG. 2B depicts a rear isometric view of the lock 140. In an embodiment, the lock 140 may be a puck lock. The lock 140 may comprise a body 141 and a key tumbler with a keyhole 143 that receives a key for locking and unlocking the lock 140. The key tumbler is movable within the body 141 of the lock 140. The key tumbler is movable between an exterior position in which the key tumbler and the keyhole 143 extend outwardly from the body 141 of the lock 140, and an interior position in which the key tumbler and the keyhole 143 are disposed within the boundaries of body 141 of the lock 140. The key tumbler is coupled to a locking pin (not visible) such that movement of the key tumbler causes corresponding movement of the locking pin. In an embodiment, the locking pin may be a cylindrical rod. The lock 140 may include a groove 144 in a back portion 145 thereof, the back portion 145 being a portion which faces the housing 110 in FIG. 1C. The groove 144 may be disposed such that the groove 144 is free of the locking pin when the key tumbler is in the exterior position and the locking pin may pass through the groove 144 along a locking pin path when the key tumbler is in the interior position. In the interior position of the key tumbler, the locking pin may engage with the device 100 so as to lock the device 100. In the exterior position of the key tumbler, the locking pin may disengage from the device 100 so as to unlock the device 100. The device 100 may thus be locked and unlocked with respect to the lock 140, and further, with respect to the socket assembly 10, as will be described further below.

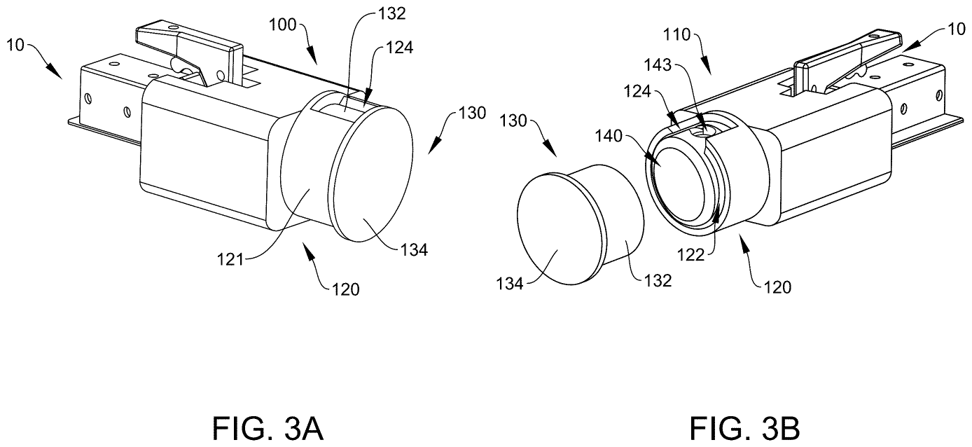

Referring additionally to FIGS. 3A-3B, the cap 130 is described. The cap 130 may be configured to engage with the locking portion 120 and prevent access to the lock 140 when the lock is received within the locking portion 120. The cap 130 may be configured to be disposed between a covering position and an uncovering position. In an embodiment, the cap 130 may be configured to be removably disposed in the covering position where the cap covers at least the opening 122 of the locking portion 120. In an embodiment, the cap 130 may be configured to be removably disposed to the covering position where the cap covers at least the gap 124 of the locking portion 120. FIG. 3A depicts the cap 130 in the covering position with respect to the device 100 in which the cap 130 is in engagement with the locking portion 120. FIG. 3B depicts the cap 130 in the uncovering position with respect to the device 100 in which the cap 130 is withdrawn from engagement with the locking portion 120.

As seen in FIG. 3A, the lock 140 is disposed within the locking portion 120. The opening 122 may allow access to the lock space 123, and the lock 140 when the lock 140 is disposed within the lock space 123. The opening 122 may allow access in a direction along the longitudinal axis X. In an embodiment, the locking portion 120 may be dimensioned so as to freely receive the lock 140 therewithin. In an embodiment where the locking portion 120 is a tubular member, the diameter of the locking portion 120 may be greater than a diameter of the lock 140.

In the covering position, the cap 130 may be configured to cover a majority of the lock 140 when the lock is in place within the locking portion 120, thereby preventing access to the lock 140 through the gap 124 and/or the opening 122 of the locking portion 120. In particular, the cap 130 may be configured to prevent access to the lock space 123 and the lock 140 received within the lock space 123. The term ‘majority’ as used herein may refer to covering more than 80%, more than 90%, or more than 95% of the lock 140.

In the covering position of the cap 130, the cap 130 may be configured to be at least partially received within the locking portion 120. In the covering position, the cap 130 may be configured to cover at least the gap 124 of the locking portion 120 so as to prevent access to the lock 140, when the lock 140 is received within the locking portion 120.

In the uncovering position of the cap 130, the lock 140 may be accessible through the opening 122 in a direction along the longitudinal axis X. Further, in the uncovering position of the cap 130, the lock 140 may be accessible through the gap 124 in a direction transverse to the longitudinal axis X.

The cap 130 may comprise a first covering member 132 and a second covering member 134. In the covering position of the cap 130, the first covering member 132 of the cap 130 may be received within the locking portion 120, for instance, within the lock space 123 of the locking portion 120. As depicted in FIG. 3A, the first covering member 132 may be configured to cover the gap 124 of the locking portion 120. In the covering position of the cap 130, the second covering member 134 of the cap 130 may be configured to cover the opening 122. For instance, the second covering member 134 may align with the opening 122 in the covering position of the cap 130. In an embodiment, the dimensions of the second covering member 134 may be substantially similar to the dimensions of the opening 122 so as to cover the opening 122.

In an embodiment, when the lock 140 is received within the locking portion 120 and the cap 130 is in the covering position, the lock 140 is completely enclosed. The lock 140 is enclosed by the wall 121 of the locking portion and the cap 130 which covers the gap 124 and the opening 122 of the locking portion 120. This way, access to the lock 140 is completely covered so that access to the lock 140, such as the keyhole 143 of the lock 140, is prevented.

In an embodiment, when the lock 140 is received within the locking portion 120 and the cap 130 is in the covering position, the lock 140 is substantially fully enclosed with the exception of sufficient access to the lock 140 to insert a key in the keyhole of the lock 140. For instance, the cap 130 may include a hole corresponding to dimensions of a key of the lock 140 so as to enable insertion of the key to access the lock 140.

In an embodiment, the cap 130 may be formed of a similar material and/or provide a similar visual appearance as the locking portion 120 and/or the housing 110. This way, when the cap 130 is in the covering position, the cap 130 may be visually seen as a part of the housing 110 and/or the locking portion 120, and not as a separate, removable component.

As described above, the device 100 may be in a locked state in which the device 100 is engaged with the socket assembly 10. In the locked state, the device 100 may restrict a movement of the socket assembly 10 with respect to the device 100. For instance, when the device 100 is engaged with the socket assembly 10 (as shown in FIG. 1A), the device 100 may prevent a movement of the socket assembly 10 in a direction along the longitudinal axis and prevent disengagement from the socket assembly 10. In order to disengage the socket assembly 10 from the device 100, the device 100 may be shifted to an unlocked state.

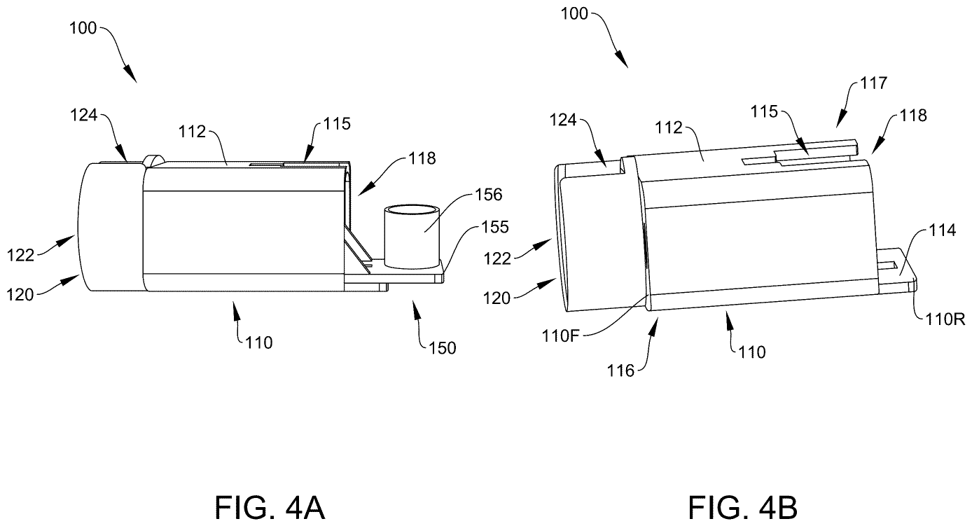

Referring to FIG. 1C and FIGS. 4A-4B, the device 100 may comprise a rearwardly sliding plate 150 configured to facilitate the device 100 to switch between the locked and unlocked states. The sliding plate may engage and disengage with the socket assembly 10, and further, may engage and disengage with the lock 140, such that the sliding plate 150 enables locking and unlocking of the device 100 with respect to the socket assembly 10 and with respect to the lock 140.

The sliding plate 150 may extend in a direction along the longitudinal axis X. The sliding plate 150 may be accommodated at least partially within the housing 110. In an embodiment, the sliding plate 150 may be disposed at or adjacent the slotted rear portion 115 of the housing 110. The sliding plate 150 may be movable in the direction along the longitudinal axis X between a front position and a rear position. In an embodiment, the sliding plate may be movable adjacent the bottom wall 114 of the housing 110. In an embodiment, the sliding plate being movable within or under the slotted rear portion 115 of the housing. In an embodiment, the sliding plate 150 may slide on the bottom wall 114. In an embodiment, the housing 110 may comprise a moving mechanism for moving the sliding plate 150.

FIG. 4A depicts the sliding plate 150 in the rear position thereof while FIG. 4B and FIG. 1C depict the sliding plate 150 in the front position thereof. In an embodiment, the sliding plate 150 may displace towards the opening 122 when moving to the front position from the rear position. In an embodiment, the sliding plate 150 may displace towards the slotted rear portion 115 and the socket receiving opening 118 when moving to the rear position from the front position.

The sliding plate 150 may extended between a front end 151 and a rear end 155. The front end 151 may be proximal to the opening 122. The sliding plate 150 may comprise a pull tab 152 disposed at the front end 151. The pull tab 152 may be configured to engage with the lock 140. In an embodiment, the pull tab 152 may be configured to be received within the groove 144 of the lock 140. As described above, the lock 140 may include a groove in a back portion 145 thereof, the back portion 145 being a portion which faces the sliding plate 150 when the lock 140 is being received within the locking portion 120. The groove 144 of the lock 140 may have an opening facing the sliding plate 150 so as to receive the pull tab 152 therewithin.

The pull tab 152 may include a plate aperture (not visible) configured to receive a locking pin of the lock 140. The plate aperture may be understood as a through-hole passing through the pull tab 152 adjacent or near the front end 151 of the sliding plate 150. As described above, the locking pin of the lock 140 may pass through the groove 144 along a locking pin path. The pull tab 152 (along with the plate aperture) may be received within the groove 144 such that the plate aperture aligns with the locking pin path. This way, when the key tumbler of the lock 140 is pushed to the interior position, the locking pin would be displaced to pass through the plate aperture. In the interior position of the key tumbler, the lock 140 is locked. Consequently, the locking pin passing through the plate aperture holds the pull tab 152 in position and locked with the lock 140.

In an embodiment, the housing 110 may include an additional tab which is aligned with the pull tab 152 when the sliding plate 150 is in the front position. The additional tab may be configured to be engaged with the lock 140 along with the pull tab 152. For instance, the additional tab may be configured to be received within the groove of the lock 140 and may comprise an aperture for receiving the locking pin of the lock 140, whereby both the pull tab 152 and the additional tab are locked with the lock 140.

Accordingly, when the lock 140 is received within the locking portion 120, the sliding plate 150 may be configured to be engaged with the lock 140 and be locked thereby. The locking of the sliding plate 150 with the lock 140 causes locking of the device 100 with the lock 140. In an embodiment, the sliding plate 150 may be locked by the lock 140 when the sliding plate 150 is in the front position thereof. The locking of the sliding plate 150 with the lock 140 restricts the movement of the sliding plate 150 towards the rear position.

As described above, the sliding plate 150 may extend between the front end 151 and the rear end 155. In an embodiment, as depicted in FIG. 4A, when the sliding plate 150 is in the rear position, the rear end 155 may extend out of the housing 110 via the socket receiving opening 118. The sliding plate 150 may comprise a male connector protrusion 156 (hereinafter referred to as the protrusion 156) disposed at or adjacent the rear end 155 of the sliding plate 150. The protrusion 156 may be configured to be coupled to the socket assembly 10. In an embodiment, the protrusion 156 may extend upwardly in a direction transverse to the longitudinal axis X. The protrusion may be configured to be received within the recess of the socket 12 of the socket assembly 10, thereby coupling the sliding plate 150 with the socket assembly 10.

In the front position of the sliding plate 150 (FIG. 4B), the protrusion 156 may be mostly enclosed by the housing, i.e., a majority of the protrusion 156 may be enclosed by the housing 110. In an embodiment, the protrusion 156 may be completely enclosed by the housing 110 in the front position of the sliding plate. In the rear position of the sliding plate 150 (FIG. 4A), the protrusion 156 may be mostly outside the rear side of the housing, i.e., a majority of the protrusion 156 may be outside the housing 110. In an embodiment, the protrusion 156 may be completely outside the housing 110 in the rear position of the sliding plate. The term ‘majority’ as used herein may refer to more than 80%, more than 90%, or more than 95% of the protrusion being enclosed.

In the rear position, the sliding plate 150 may be configured to allow detachable attachment, i.e., coupling and decoupling, of the socket assembly 10 with the sliding plate 150. In particular, in the rear position of the sliding plate 150, the protrusion 156 may engage and disengage with the socket 12 of the socket assembly 10. In the rear position of the sliding plate 150, the movement of the socket 12 with respect to the protrusion 156 is not hindered by the housing 110. The socket 12 may be displaced in a direction transverse the longitudinal axis X so as to engage and disengage with the protrusion 156.

In the front position, the sliding plate 150 may be configured to engage with the lock 140 and be locked thereby so as to restrict the movement of the sliding plate 150 to the rear position. In particular, the pull tab 152 may be received within the groove 144 of the lock 140 and be locked by the locking pin of the lock 140. Further, in the front position, the sliding plate may be configured to disengage with the lock 140, wherein, the locking pin may disengage from the pull tab 152 and the pull tab 152 is free to be moved out of the groove 144 by sliding the sliding plate 150 towards the rear position.

The device 100 may be disposed between a locked state and an unlocked state. In the locked state, the device 100 may be in engagement with the socket assembly 10 so as to prevent the movement of the socket assembly 10 and prevent access to the socket 12 of the socket assembly 10. When the sliding plate 150 is engaged and locked with the lock 140, the device 100 is in the locked state. When the sliding plate 150 is not locked by the lock 140, the device 100 is in the unlocked state.

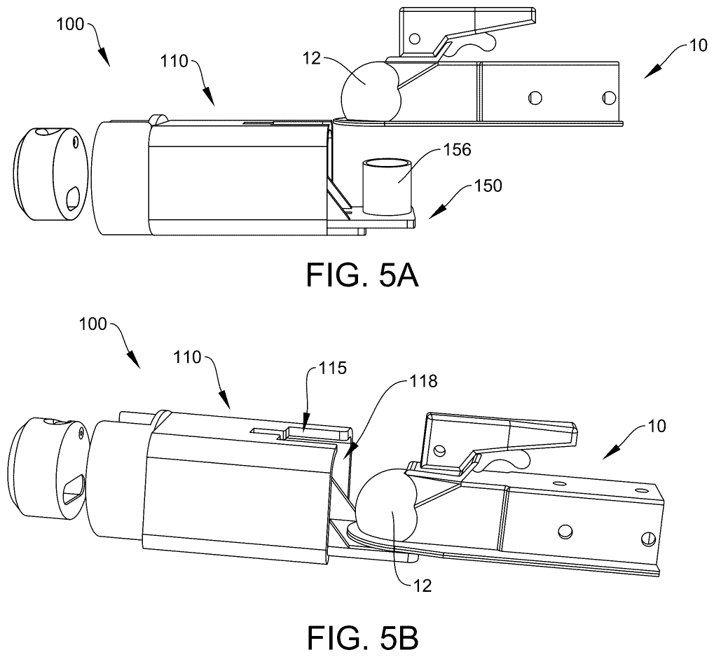

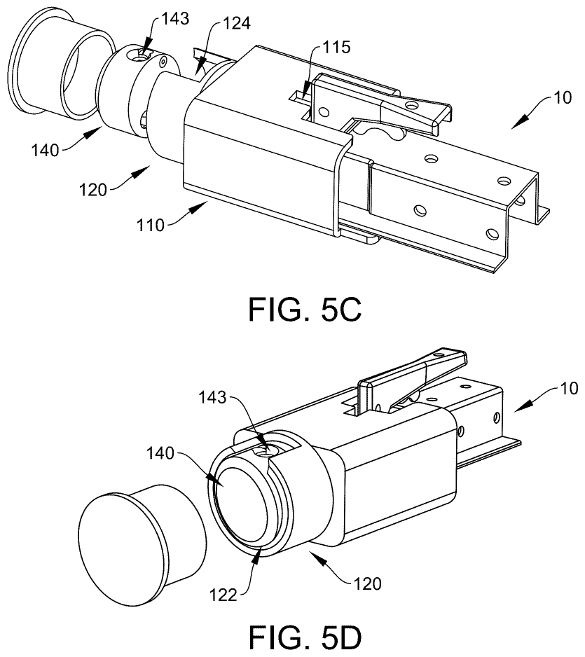

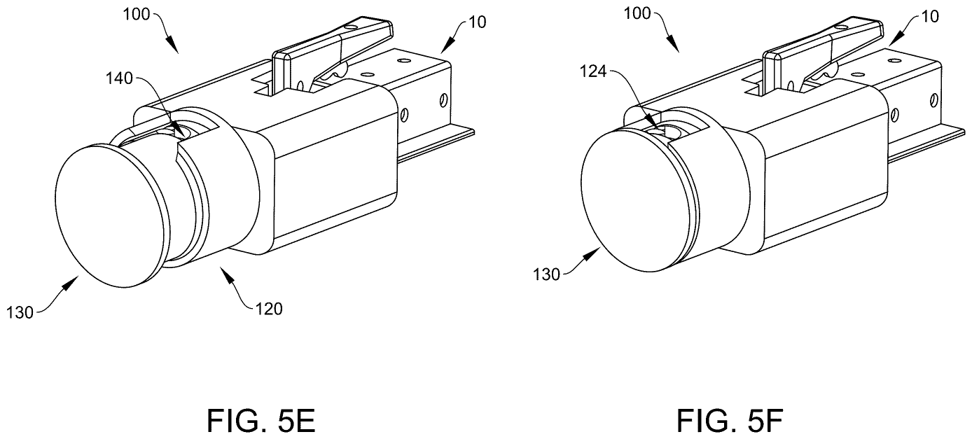

Referring to FIGS. 5A-5F, various sequential stages in shifting the device 100 from the unlocked state to the locked state are depicted. The operation of the device 100 will be described with reference to FIGS. 5A-5F.

In FIG. 5A, the device 100 is in the unlocked state and it is desired to engage the device 100 with the socket assembly 10. The sliding plate 150 is in the rear position. The socket assembly 10 can be moved relative to the device 100 such that the protrusion 156 is received within the socket 12 of the socket assembly 10. As the sliding plate 150 is in the rear position, the housing 110 does not hinder the protrusion 156 being received within the socket 12 of the socket assembly 10.

In FIG. 5B, the protrusion 156 is received within the socket 12 of the socket assembly 10. The sliding plate 150 is thus in engagement with the socket assembly.

In FIG. 5C, the sliding plate 150, engaged with the socket assembly 10, is moved from the rear position to the front position, in the direction along the longitudinal axis X. When the sliding plate 150 is coupled with the socket assembly 10, the movement of the sliding plate 150 from the rear position to the front position causes the socket assembly 10 to be received at least partially within the housing 110 via the socket receiving opening 118 of the housing. As depicted, the socket receiving opening 118 and the slotted rear portion 115 allows the socket assembly 10 to be received within the housing 110. In an embodiment, when the socket assembly 10 is received at least partially within the housing, a majority of the protrusion 156 and the socket 12 is enclosed by the housing 110. In an embodiment, when the socket assembly 10 is received at least partially within the housing, an entirety of the protrusion 156 and the socket 12 is enclosed by the housing 110.

In FIG. 5D, the sliding plate 150 is in the front position (not visible) and the lock 140 is received within the lock receiving opening 120. It is desired to lock the sliding plate 150 in the front position, and consequently lock the device 100 in the locked state with respect to the socket assembly 10. Prior to the stage of FIG, 5D, a user may access the sliding plate 150 via the opening 122. The user may position the lock 140 within the locking portion 120. At this time, the lock 140 may be unlocked and the key tumbler may be in the exterior position such that the groove is free of the locking pin. The pull tab 152 may be received within the groove 144 of the lock 140. The user may then push the key tumbler into the interior position, which causes the locking pin to pass through the plate aperture. The user may lock the locking pin in position (for instance, by rotating the key in the keyhole 143), thereby fixing the sliding plate 150 in the front position thereof. The sliding plate 150 (engaged with the socket assembly 10) is thus locked with the lock and the device 100 is in the locked state. In the locked state, the lock 140 prevents movement of the sliding plate 150 towards the rear position. Accordingly, the socket assembly 10 engaged with the sliding plate 150 and enclosed by the housing 110 also cannot move out of the housing 110. The socket 12 of the socket assembly 10 cannot be accessed for coupling to a towing vehicle till the device 100 is in the locked state.

In FIG. 5E, the cap 130 can be shifted from the uncovering position to the covering position. In FIG. 5F, the cap 130 is in the covering position. The lock 140 is enclosed by the locking portion 120 and the cap 130. Access to the lock 140 is covered by the locking portion 120 and the cap 130, which discourages an authorized person to tamper with the device 100 since any part of the lock, such as the keyhole, is not readily visible to the unauthorized person. For instance, an unauthorized person would not think of opening the cap and accessing the lock for tampering.

In order to switch the device 100 from the locked state to the unlocked state, the cap 130 may be shifted from the covering position to the uncovering position. The lock 140 may be accessed via the locking portion 120. The lock 140 may be disengaged from the sliding plate 150, for instance, by shifting the key tumbler to the exterior position to disengage the locking pin from the pull tab 152. The lock 140 may be withdrawn from the locking portion 120 via the opening 122 and the sliding plate 150 may be shifted (for instance, by pulling the socket assembly 10) to the rear position. The device 100 is in the unlocked state and the socket assembly 10 can be disengaged from the protrusion 156. The socket assembly 10 is now free to engage with a towing vehicle.

The device 100 may thus be selectively switched between the unlocked state and the locked state to selectively secure the socket assembly 10. As the device 100 prevents movement of the socket assembly 10 and access to the socket 12, the socket assembly 10 is prevented from being engaged to a towing vehicle. For instance, an unauthorized person cannot access the socket assembly 10 in view of the device 100 being in the locked state for engaging with a towing hitch of a towing vehicle. Accordingly, the device 100 secures the socket assembly 10 of a trailer and prevents unauthorized access to the socket assembly 10. A robust device to secure a trailer is thus provided which provides superior security. This ensures that the trailer remains protected, for instance, when unhitched.

Although the present disclosure and its advantages have been described in detail, it should be understood that various changes, substitutions and alterations can be made herein without departing from the spirit and scope of the disclosure as defined by the appended. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A device for securing with a socket assembly of a trailer hitch, the device comprising:
a housing having at least a longitudinal axis, the housing comprising a bottom wall, a top wall portion having a slotted rear portion and a first end portion at the front end thereof;
a locking portion extending from the first end portion of the housing at least partially along the longitudinal axis, the locking portion configured to receive a lock therewithin, wherein the locking portion defines an opening at the front end of the locking portion to retain a lock therein and to allow access to the lock through the locking portion;
a rearwardly sliding plate disposed in the slotted rear portion of the housing and having a male connector protrusion configured to be coupled to the socket assembly of the trailer hitch, the sliding plate being movable adjacent the bottom wall within the slotted rear portion of the housing between a front position where the male connector protrusion is at least mostly enclosed by the housing and a rear position where the male connector protrusion is at least mostly outside the rear of the housing, wherein:
at the rear position, the sliding plate is configured to allow detachable attachment of the socket assembly of the trailer hitch with the sliding plate, and
at the front position, the sliding plate is configured to be engaged with the lock and be locked thereby so as to restrict the movement of the sliding plate to the rear position; and
a cap configured to be removably disposed in a covering position where the cap covers at least the opening of the locking portion and a majority of the lock when the lock is in place, thereby preventing access to the lock through the opening of the locking portion.

2. The device of claim 1, wherein the locking portion is integrally formed with the housing.

3. The device of claim 1, wherein the locking portion comprises a gap configured to allow access to the lock through the locking portion.

4. The device of claim 3, wherein the cap is configured to cover the gap in the covering position thereof so as to prevent access to the lock via the gap.

5. The device of claim 1, wherein the cap is configured to be at least partially received within the locking portion in the covering position thereof.

6. The device of claim 5, wherein the cap comprises a first covering member configured to cover the gap and a second covering member configured to cover the lock receiving opening, when the cap is in the covering position.

7. The device of claim 1, wherein the cap is configured to be disposed at an uncovering position in which the lock is accessible through the opening of the locking portion.

8. The device of claim 3, wherein the cap is configured to be disposed at an uncovering position in which the lock is accessible through the gap of the locking portion.

9. The device of claim 3, wherein the locking portion is a tubular member comprising a tubular wall, and wherein the gap is formed in the tubular wall of the tubular member, the gap defining an access passage through the tubular wall.

10. The device of claim 1, wherein the sliding plate comprises a pull tab disposed at a front end of the sliding plate, the pull tab being configured to engage with the lock when the sliding plate is at the front position thereof.

11. The device of claim 10, wherein when the locking portion comprises the lock therewithin and the sliding plate is at the front position thereof and, the pull tab is configured to be received within a groove of the lock.

12. The device of claim 10, wherein the pull tab comprises an aperture configured to receive a locking pin of the lock, thereby restricting the movement of the sliding plate towards the rear position.

13. The device of claim 1, wherein the housing comprises side walls, which along with the top wall portion define an internal space configured to at least partially accommodate the sliding plate therewithin.

14. The device of claim 13, wherein the housing comprising a second end portion, the second end portion defining a socket receiving opening configured to allow the socket assembly to be received at least partially within the housing.

15. The device of claim 14, wherein the socket receiving opening is partially formed in the top wall portion of the housing.

16. The device of claim 14, wherein when the sliding plate is coupled with the socket assembly, the movement of the sliding plate from the rear position to the front position causes the socket assembly to be received at least partially within the housing via the socket receiving opening of the housing.

17. The device of claim 1, wherein the male connector protrusion is configured to be received within a recess of the socket assembly, thereby coupling the sliding plate with the socket assembly.

18. The device of claim 17, wherein the male connector protrusion is disposed adjacent a rear end of the sliding plate.

19. The device of claim 17, wherein the male connector protrusion extends from the sliding plate in a direction transverse the longitudinal axis.
